(19) United States
(12) Patent Application Publication
(10) Pub. No.: US 2023/0352683 A1
(43) Pub. Date: Nov. 2, 2023

(54) SIOC COMPOSITE MATERIAL AND PREPARATION METHOD AND APPLICATION THEREOF

(71) Applicant: Ningde Amperex Technology Limited, Ningde City (CN)

(72) Inventor: Ting Yi, Ningde City (CN)

(73) Assignee: Ningde Amperex Technology Limited, Ningde City (CN)

(21) Appl. No.: 18/214,620

(22) Filed: Jun. 27, 2023

Related U.S. Application Data
(63) Continuation of application No. PCT/CN2020/140365, filed on Dec. 28, 2020.

(51) Int. Cl. H01M 4/58; H01M 4/04; H01M 10/0569

(52) U.S. Cl. CPC H01M 4/58; H01M 4/0471; H01M 4/0404; H01M 10/0569; H01M 2004/021

(57) ABSTRACT

A SiOC composite material is in the form of particles, where the particle includes a nucleus formed from a SiOC material, and the nucleus has a carbon fin present on the surface; and a short axis of a largest cross section of the nucleus of any one of the particles is a, a long axis is b, 0.8<a/b≤1, and the particles have a porous structure. The SiOC composite material provided in the present invention has good stability, is not prone to swelling during the battery cycling, and has good conductivity, facilitating functions such as capacity performance and electron transport of the SiOC composite material as a silicon negative electrode material, and exhibiting excellent performances such as high capacity, long cycle life, and low swelling rate. This effectively solves the problems such as volume swelling and poor cycling performance in the battery charge-discharge cycles.

### CROSS REFERENCES TO RELATED APPLICATIONS

The present application is a continuation application of PCT/CN2020/140365, filed on Dec. 28, 2020, the disclosure of which is hereby incorporated by reference in its entirety.

### TECHNICAL FIELD

The present invention relates to the field of batteries, specifically to a SiOC composite material and a preparation method and application thereof and more specifically to a negative electrode active material using the SiOC composite material, a negative electrode plate and a preparation method thereof, a battery, and an electronic apparatus.

### BACKGROUND

One purpose of technological innovation in lithium-ion batteries is to continuously improve the energy density. At present, the actual capacity of mainstream graphite materials is close to the theoretical capacity (372 mAh/g), and there is already a bottleneck in improving the energy density. Silicon-based negative electrode materials (or silicon materials) are attracting attention and research because of their advantages such as abundant reserves, ultra-high theoretical capacity (4200 mAh/g), and environmental friendliness. However, in the charge and discharge cycle of a battery, as lithium ions are intercalated and deintercalated, a silicon material tends to undergo a volume change (that is, volume swelling) of 120% to 300% or even higher than 300%, causing the silicon material to be pulverized and separated from a current collector, thus resulting in poor conductivity of a negative electrode and reduced cycling performance of the lithium-ion battery, specifically manifested in rapid attenuation during the battery cycling (capacity retention rate after 400 cycles is lower than 80%). In addition, the poor conductivity of conventional silicon materials (<1 S/m) is also an important factor affecting the cycling performance of the lithium-ion battery.

At present, the main methods to solve the problems of volume swelling and poor conductivity of the silicon materials during battery cycling are as follows. (1) Nanosizing silicon materials. Studies have shown that the volume change of nano-silicon materials during battery cycling is small (volume swelling rate <300%). Compared with non-nanomaterials (particle size >1 μm), nanomaterials are not easily broken or pulverized after swelling, which is conducive to maintaining the structural stability of the materials. However, nanomaterials of a large specific surface area (nanomaterials with a particle size less than 100 nm can have a specific surface area of up to 100 m²/g) usually consume more electrolyte solution to form SEI films, resulting in a low initial coulombic efficiency of the battery (<80%). Moreover, the nano-silicon materials still have defects such as difficult preparation and high price, limiting their practical application. (2) Performing surface coating and modification for silicon materials. Carbon coating is one of the commonly used ways of increasing the conductivity of silicon materials to some extent (the conductivity of ordinary silicon materials can be increased to about 100 S/m after carbon coating) and alleviating the swelling of silicon materials (volume swelling rate is generally about 80% to 110%). However, the conductivity of carbon-coated silicon materials formed by coating methods such as conventional CVD alkyne gas coating and solid-phase pitch coating and the volume swelling during cycling have limited improvement, and the problems of electrical contact failure caused by the swelling of the silicon negative electrode during the cycling cannot be effectively solved. (3) Mixing silicon-containing materials with graphite or other materials (for example, metals or non-metals). Performances such as conductivity (conductivity >500 S/m) of graphite and other materials can be used to alleviate the volume swelling (volume swelling rate <10%) of silicon materials during the cycling to some extent and to increase the conductivity (conductivity >100 S/m) of the system. However, mechanical mixing leads to a poor uniformity of the mixture, and to ensure the contact between graphite and silicon material particles during the cycling, it is often necessary to rely on a binder with high bonding force (>30 N/m), which often decreases rate performance of the battery. (4) Optimizing a binder used for silicon negative electrode to increase a bonding force (generally >30 N/m) of the silicon-containing negative electrode and restrain the swelling of silicon materials (volume swelling rate <10%). However, this method has an unsatisfactory improvement effect in terms of volume swelling and conductivity of the silicon negative electrode, and the use of binder with high bonding force will affect the rate performance of the battery.

Considering the improvement effect in terms of volume swelling and conductivity of silicon negative electrodes, as well as the costs and difficulty of operation process, carbon coating holds some advantages over other solutions mentioned above and gradually becomes a research hotspot in this field. However, as mentioned above, the volume swelling and conductivity of carbon-coated silicon negative electrode materials need to be further addressed at this stage.

### SUMMARY

The present invention provides a SiOC composite material and a preparation method and application thereof to solve at least the problems in the prior art in terms of easy swelling and poor conductivity of the silicon negative electrode material, and the resulting poor cycling performance and high swelling rate of the battery.

According to an aspect of the present invention, a SiOC composite material is provided. The SiOC composite material is in the form of particles, where the particle includes a nucleus formed from a SiOC material, and the nucleus has a carbon film present on the surface; and a short axis of a largest cross section of the nucleus of any one of the particles is a, a long axis is b, 0.8<a/b≤1, and the particles have a porous structure.

According to an embodiment of the present invention, the carbon film has a thickness of 15 nm to 50 nm, preferably 15 nm to 30 nm, and/or the nucleus has an average particle size of 5 μm to 15 μm, preferably 5 μm to 10 μm; the particles have a surface microscopic morphology of fibers, and the fiber has a fiber length of 15 nm to 50 nm, preferably 20 nm to 50 nm; and the carbon film in the particle has a mass percentage of 2% to 4%

According to an embodiment of the present invention, in Raman spectroscopy test results of the SiOC composite material, a ratio of peak height I₅₁₀ at 510 cm⁻¹, peak height I₁₃₅₀ at 1350 cm⁻¹, and peak height I₁₅₈₀ at 1580 cm⁻¹ satisfies 1.0<I₁₃₅₀/I₁₅₈₀<3 and I₅₁₀/I₁₃₅₀=0; and positions of element silicon in sNMR detection results of the SiOC composite material include −5 ppm, −35 ppm, −75 ppm, and −110 ppm, and a half-peak width K at −5 ppm satisfies 7 ppm<K<28 ppm.

According to an embodiment of the present invention, the particles have microporous and mesoporous structures.

According to another aspect of the present invention, a preparation method of the foregoing SiOC composite material is provided, including: performing pyrolysis treatment for a raw material system containing an organic silicon source to obtain the SiOC material; performing powder grading and physical shaping treatments for the SiOC material to form a product containing the nuclei; and forming a carbon film on the surface of the nucleus in the product through chemical vapor deposition to obtain the SiOC composite material in the form of the particles.

According to still another aspect of the present invention, a negative electrode active material is further provided, including the foregoing SiOC composite material, where the SiOC composite material has a mass percentage of not lower than 5% in the negative electrode active material.

According to still another aspect of the present invention, a negative electrode plate is provided, including a negative electrode current collector and a functional layer applied on at least one surface of the negative electrode current collector, where a negative electrode active material of the functional layer includes the foregoing SiOC composite material or the foregoing negative electrode active material; and the functional layer has a thickness of 70 μm to 90 μm and/or a compacted density of 1.5 g/cm³ to 2.0 g/cm³.

According to still another aspect of the present invention, a preparation method of the foregoing negative electrode plate is provided, including: applying a slurry containing a raw material of the functional layer to at least one surface of the negative electrode current collector and forming the functional layer to obtain the negative electrode plate, where the slurry has a solid percentage of 35% to 50%; and/or the slurry has a viscosity of 1500 mPas to 4000 mPas.

According to still another aspect of the present invention, an electrochemical apparatus is provided, including the foregoing negative electrode plate. According to an embodiment of the present invention, the organic solvent includes vinyl fluorocarbonate, and the vinyl fluorocarbonate has a mass percentage of 3% to 25% based on a total mass of the liquid electrolyte.

According to still another aspect of the present invention, an electronic apparatus is provided, including the foregoing electrochemical apparatus.

The implementation of the present invention has at least the following beneficial effects: The SiOC composite material provided in the present invention has good stability, is not prone to swelling during the battery cycling, and has good conductivity, facilitating capacity performance and electron transport of the SiOC composite material as a silicon negative electrode material. The SiOC composite material exhibits excellent performances such as high capacity, long cycle life, and low swelling rate, which enable the negative electrode plate/battery to have good cycling performance, low internal resistance, good stability and safety, and other performances, effectively solving the problems of volume swelling and poor cycling performance in the battery charge-discharge cycles. This is of great importance for practical industrial application. Studies have shown that the battery formed by using the foregoing SiOC composite material has a volume swelling rate of no more than 8% and a capacity retention rate of no lower than 87% after 400 cycles at 25° C. The preparation method of the SiOC composite material provided in the present invention can produce the foregoing SiOC composite material with excellent performance, and has the advantages such as simple preparation process and easy operation.

### BRIEF DESCRIPTION OF DRAWINGS

FIG. 1 and FIG. 2 are schematic scanning electron microscopy (SEM) analysis diagrams of a SiOC composite material according to an embodiment of the present invention;

FIG. 3 is a schematic transmission electron microscopy analysis diagram of a SiOC composite material according to an embodiment of the present invention;

FIG. 4 is a nitrogen adsorption isothermal diagram of a SiOC composite material according to an embodiment of the present invention with relative pressure in the horizontal coordinate and volume absorbed (volume absorbed) in the vertical coordinate; and

FIG. 5 is a graph showing capacity fade curves of examples and comparative examples during battery cycling according to the present invention.

### DETAILED DESCRIPTION

To make persons skilled in the art better understand the solutions of the present invention, the following further describes the present invention in detail.

According to an aspect of the present invention, a SiOC composite material is provided. The SiOC composite material is in the form of particles, where the particle includes a nucleus formed from a SiOC material, and the nucleus has a carbon film present on the surface; and a short axis of a largest cross section of the nucleus of any one of the particles is a, a long axis is b, 0.8<a/b≤1, and the particles have a porous structure.

Specifically, the SiOC composite material of the present invention is in the form of the foregoing particles, the foregoing nucleus is a spherical structure and has the carbon film on its surface, in other words, the SiOC nucleus is covered with the carbon film on its surface. Controlling the foregoing sphericity (0.8<a/b≤1) and porous structure can effectively alleviate the cyclic swelling of the silicon negative electrode material during the battery cycling (after lithium intercalation), and can effectively improve the conductivity of the SiOC composite material, which facilitate its capacity performance and electronic transmission. Moreover, controlling the foregoing sphericity (0.8<a/b≤1) facilitates a more uniform distribution of swelling stress during the battery cycling (after lithium intercalation), alleviates material rupture, differentiation, and the like caused by excessively high local stress, and thus prevents the problems such as electrical contact failure. Therefore, the SiOC composite material of the present invention has the performances such as high capacity, long cycle life, and low swelling rate.

In the present invention, there is generally a carbon film of uniform thickness on the surface of the nuclei, and the structure of the particle formed by the nuclei and the carbon film is substantially spherical. The largest cross section is any one of cross sections of the nucleus over the center point (sphere center). In general, the value of a/b closer to 1 makes the nucleus in a more regular spherical shape (and correspondingly the particles in a more regular spherical shape), which makes the isotropy and swelling stress distribution of the particles more uniform and usually allows the particles to have better performance like high capacity and low swelling. However, the value of a/b closer to 1 also imposes more stringent requirements for the preparation process of the SiOC composite material. Considering all these factors, in an embodiment of the present invention, 0.85≤a/b≤0.98.

According to the study of the present invention, the thickness of the carbon film may generally range from 15 nm into 50 nm, and further may range from 15 nm to 30 nm, for example, the thickness may be 20 nm±5 nm and/or the average particle size of the nucleus may range from 5 μm to 15 μm, and further may range from 5 μm to 10 μm, for example, the average particle size may be 5.5 μm, which is conducive to achieving low swelling rate, long cycle life, and high capacity of the SiOC composite material.

Further, the particles (specifically, the surface of the carbon film) have a surface microscopic morphology of fibers, and the fiber has a fiber length of 15 nm to 50 nm, preferably 20 nm to 50 nm, and more preferably 20 mm to 30 nm. The fiber length is generally equal to thickness of the fiber layer. The particles have a fibrous surface which can implement long-range conductivity, thus further enhancing the conductivity of the SiOC composite material during the battery cycling. This makes the battery exhibit excellent performance such as higher capacity retention rate and lower swelling rate. Specifically, in the present invention, conventional instruments or methods in the field, for example, transmission electron microscopy (TEM), can be used to detect the surface microscopic morphology of the particles and their fiber length.

Further, the carbon film has a mass percentage of 2% to 4% in the foregoing particles, for example, the mass percentage may be 2.5%±0.5%.

According to the further study of the present invention, in Raman spectroscopy test results of the SiOC composite material, a ratio of peak height I₅₁₀ at 510 cm⁻¹, peak height I₁₃₅₀ at 1350 cm⁻¹, and peak height I₁₅₈₀ at 1580 cm⁻¹ satisfies 1.0<I₁₃₅₀/I₁₅₈₀<3, I₁₃₅₀/I₁₅₈₀ may be, for example, 1.2, 1.8, 2.0, or 2.5, and I₅₁₀/I₁₃₅₀=0. The use of the SiOC composite material can achieve low swelling rate, long cycle life, and high capacity.

Further, positions of element silicon in sNMR (solid-state nuclear magnetic resonance technology) detection results of the SiOC composite material include −5 ppm, −35 ppm, −75 ppm, and −110 ppm, and a half-peak width K at −5 ppm satisfies 7 ppm<K<28 ppm, where K may be, for example, 10 ppm, 15 ppm, 20 ppm, or 25 ppm.

The particles have a porous structure, which is beneficial to suppress the volume swelling of the SiOC composite material during the battery cycling. Specifically, in an embodiment of the present invention, a nitrogen adsorption isotherm of the SiOC composite material is of type IV. The particles have microporous and mesoporous structures, and the nitrogen adsorption isotherm of the particles is of type IV.

According to another aspect of the present invention, a preparation method of the foregoing SiOC composite material is provided, including: performing pyrolysis treatment for a raw material system containing an organic silicon source to obtain the SiOC material; performing powder grading and physical shaping treatments for the SiOC material to form a product containing the nuclei; and forming a carbon film on the surface of the nucleus in the product through chemical vapor deposition to obtain the SiOC composite material in the form of the particles.

In the preparation method provided in the present invention, a silicon-containing organic material (that is, the foregoing organic silicon source) is pyrolyzed to obtain a SiOC material, the material is further subjected to powder grading and physical shaping treatments to form the particles having a nucleus of the foregoing shape, and then a carbon film is formed on the particle (that is, the foregoing nucleus) through chemical vapor deposition (CVD) to produce the SiOC composite material in the form of particles. In addition to having the advantages of simple preparation process and easy availability of raw materials, the SiOC composite material can be optimized in terms of low swelling rate, long cycle life, and high capacity, which is more conducive to practical application and promotion.

Conventional silicon-containing organic substances in the field can be used in the present invention, provided that the SiOC material can be prepared. In a preferred embodiment, the foregoing organic silicon source may specifically include polydimethylsiloxane.

To further optimize the performances of the SiOC composite material, in an embodiment of the present invention, the foregoing raw material system further includes an organic small molecule compound containing a reactive group capable of reacting with the organic silicon source. Further, the organic small molecule compound may include glucose.

In a specific embodiment, the foregoing pyrolysis treatment can be carried out under an inert atmosphere such as nitrogen (N₂), and the organic silicon source can be heated to a pyrolyzed temperature for pyrolysis treatment in a stepwise heating manner. For example, the organic silicon source can be heated at a heating rate of 1±0.5° C./min to 500±100° C. held at this temperature for 30±10 min, then heated at a heating rate of 3±1° C. to 1100±200° C., and then held at this temperature for 3±1 hours (h) for pyrolysis to obtain a SiOC material.

Specifically, the organic silicon source may be mixed with the organic small molecule compound, and the resulting mixture is then subjected to the foregoing stepwise heating and pyrolysis treatments. In a preferred embodiment, the organic silicon source and the organic small molecule compound may be well mixed in the solvent, and then heated and stirred at 80±10° C. to remove the solvent, the resulting solvent-removed product is dried at 80±10° C., for 24±4 hours to obtain the dried product, and then the dried product is subjected to the foregoing stepwise heating and pyrolysis treatments to obtain the SiOC material.

In specific implementation, the SiOC material can be demagnetized followed by powder grading and physical shaping treatments, and parameters such as the shape, size, and sphericity of the formed nucleus can be regulated through the powder grading and physical shaping treatments, such that the SiOC material forms particles in the shape of the foregoing nucleus, that is, a product containing the foregoing nuclei is formed. The product macroscopically appears as powder (that is, a powder product), and the powder product includes the foregoing nuclei, and generally is composed of the foregoing nuclei. In the present invention, the demagnetization, powder grading, and physical shaping treatments can be carried out using conventional methods in the field, which is not particularly limited and will not be described herein.

Specifically, the CVD is performed in the following conditions: temperature (CVD treatment temperature) of 900° C. to 1100° C. and time (CVD treatment duration) of 60 min to 180 min. These conditions are conducive to achieving lower swelling rate, longer cycle life, and higher capacity of the resulting SiOC composite material. Specifically, according to the study of the present invention, when the CVD treatment duration is less than 60 min, the percentage of carbon contained in the formed particles is low and the conductivity is weak, which affects the cycling performance of the SiOC composite material; and when the CVD treatment duration is greater than 180 min, the particles have a thick carbon film on the surface and have a large specific surface area, so the lithium consumed in SEI increases during the cycling, and the cycling attenuation is accelerated. In addition, due to the increased thickness of the carbon film, the contact between the carbon film and the silicon-oxygen body (that is, the nuclei) becomes weaker, which may cause the carbon film to peel off during the cycling and cause the conductivity of the electrode plate to become worse at the later stage of the cycling, resulting in a decrease in the cycle capacity.

Further, the CVD treatment duration may be 70 min to 170 min, 80 min to 160 min, 90 min to 150 min, 100 min to 150 min, 100 min to 140 min, 110 min to 130 min, or 115 min to 125 min. Further, the CVD treatment temperature may be 900° C. to 1000° C., 950° C. to 1000° C., 950° C. to 980° C. or 950° C. to 970° C.

In specific implementation, the CVD treatment can be carried out in an inert atmosphere such as argon (Ar). The product containing the foregoing nuclei can be heated to the CVD treatment temperature at a heating rate of 20±5° C./min and then held at this temperature for some time, during which the formation of the carbon film on the surface of the nuclei (specifically, a carbon coating treatment, in which a carbon film covering the nucleus is formed on the surface of the nucleus) is completed, where the duration for holding the temperature may be generally 120±20 min. After that, the carbon source is turned off immediately, and the temperature drops to room temperature in an inert atmosphere, and then the product with a carbon film formed on the surface of the nuclei (carbon coating product) is taken out. In this way, the SiOC composite material is obtained. The product macroscopically appears as powder (that is, a powder product), and the powder product includes the foregoing particles, and generally is composed of the foregoing particles.

Specifically, the carbon source (gas) used for the CVD treatment may include at least one of methane, ethylene, or acetylene. In a preferred embodiment, the carbon source includes methane, which is more conducive to improving the performance of the SiOC composite material. One of presumptive reasons is that the carbon film formed on the surface of the SiOC nucleus using a carbon source gas such as the foregoing methane is mom likely to exhibit a fibrous structure that plays a long-range conductivity function, thus improving the performances such as conductivity of the SiOC composite material.

According to still another aspect of the present invention, a negative electrode active material is provided, including the foregoing SiOC composite material. Specifically, in the negative electrode active material, a mass percentage of the SiOC composite material is not lower than 5%, to be specific, may range from 5% to 100%.

Further, the negative electrode active material may further include graphite, which facilitates further suppression of the cyclic swelling of the silicon negative electrode. Specifically, the graphite may include at least one of natural graphite, artificial graphite, or meso-carbon microbeads.

Further, a mass ratio of the SiOC composite material to graphite in the negative electrode active material may generally range from 1:4 to 1:10, for example, it may range from 1:5 to 1:8, from 1:5 to 1:7, or from 1:5.5 to 1:6.5.

According to still another aspect of the present invention, a negative electrode plate is provided, including a negative electrode current collector and a functional layer applied on at least one surface of the negative electrode current collector, where a negative electrode active material of the functional layer includes the foregoing SiOC composite material or the foregoing negative electrode active material. Specifically, the functional layer may have a thickness of 70 μm to 90 μm, and/or may have a compacted density of 1.5 g/cm³ to 2.0 g/cm³.

Further, the raw material of the functional layer includes a conductive agent, a binder, and the negative electrode active material, where the negative electrode active material has a mass percentage of 93.5% to 96%, for example, the mass percentage may be 95.25%; and/or the conductive agent has a mass percentage of 0.4% to 1.2%, for example, the mass percentage may be 0.75%; and/or the binder has a mass percentage of 2.8% to 4.5%, for example, the mass percentage may be 4%.

Specifically, the conductive agent may include at least one of conductive carbon black, acetylene black, Ketjen black, conductive graphite, and graphene; and/or the binder may include at least one of polyacrylate, polyimide, polyamide, polyamideimide, polyfluoroethylene, styrene butadiene rubber, sodium alginate, polyvinyl alcohol, polytetrafluoroethylene, polyacrylonitrile, sodium carboxymethyl cellulose, potassium carboxymethyl cellulose, sodium hydroxymethyl cellulose, or potassium hydroxymethyl cellulose.

Specifically, the negative electrode current collector may be a conventional negative electrode current collector in the field such as copper foil, which is not particularly limited in the present invention.

According to still another aspect of the present invention, a preparation method of the foregoing negative electrode plate is provided, including: applying a slurry containing a raw material of the functional layer to at least one surface of the negative electrode current collector and forming the functional layer to obtain the negative electrode plate. Specifically, the slurry has a solid percentage of 35% to 50%; and/or the slurry has a viscosity of 1500 mPas to 4000 mPas.

In specific implementation, the negative electrode active material, the conductive agent, and the binder can be well mixed in a solvent to form the foregoing slurry, and the slurry can be applied onto the negative electrode current collector, followed by processes such as drying/baking and rolling/cold pressing, to from a functional layer, and then the negative electrode plate is produced. The solvent may be a conventional solvent in the field such as water, and the coating thickness (that is, thickness before drying and rolling) of the slurry on the negative electrode current collector may be 50 μm to 200 μm. In the present invention, the processes such as drying/baking and rolling/cold pressing can be carried out by using conventional methods in the art, and details are not described herein.

According to still another aspect of the present invention, an electrochemical apparatus is provided, including the foregoing negative electrode plate. Specifically, the electrochemical apparatus may be a secondary battery, and may further be a lithium-ion battery.

The electrochemical apparatus further includes an electrolyte, where the electrolyte may specifically be a liquid electrolyte (or electrolyte solution). A raw material of the electrolyte may generally include an organic solvent, a lithium salt, and an additive, where the organic solvent includes fluorinated ethylene carbonate (FEC), ethylene carbonate (EC), propylene carbonate (PC), diethyl carbonate (DEC), ethyl methyl carbonate (EMC), dimethyl carbonate (DMC), propylene carbonate, or ethyl propionate; and/or the lithium salt may include at least one of an organic lithium salt and an inorganic lithium salt, and may specifically include at least one of lithium hexafluorophosphate (LiPF₆), lithium tetrafluoroborate (LiBF₄), lithium difluorophosphate (LiPO₂F₂), lithium bistrifluoromethanesulfonylimide LiN(CF₃SO₂)₂ (LiTFSI), lithium bis(fluorosulfonyl)imide Li(N(SO₂F)₂) (LiFSI), LiB(C2O₄)₂ (LiBOB), or LiBF₂(C₂O₄) (LiDFOB); and/or the additive includes at least one of a crown ether compound, a boron-based compound, an inorganic nanooxide, a carbonate compound, or an amide compound, for example, may include at least one of 12-crown-4 ether, a boron-based anion acceptor tris(pentafluorophenyl)borane (TFPB), a tris(pentafluorophenyl)borate, a vinylidene carbonate (VC), or an acetamide and its derivatives.

Further, in the liquid electrolyte, the lithium salt has a concentration of 0.5 mol/L to 1.5 mol/L, for example, 0.7 mol/L to 1.3 mol/L or 0.9 mol/L to 1.1 mol/L. Further, the lithium salt includes lithium hexafluorophosphate.

In some embodiments, the electrochemical apparatus includes a liquid electrolyte containing the foregoing organic solvent, where the organic solvent includes vinyl fluorocarbonate, and a mass fraction of vinyl fluorocarbonate ranges from 3% to 25% based on a total mass of the liquid electrolyte (to be specific, a mass percentage of vinyl fluorocarbonate in the electrolyte solution ranges from 3% to 25%), for example, from 3% to 20%, from 5% to 20%, from 5% to 18%, from 7% to 15%, from 8% to 13%, or from 9% to 11%. According to the study of the present invention, FEC plays an important role in the performances such as long cycle life of the battery. FEC can form a more stable SEI film on the surface of the silicon negative electrode. When a percentage of FEC is lower than 3%, the SEI film is less stable, the SiOC composite material tends to swell and break during cycling, and the fresh interface of the small particles formed is exposed and continues to react with the electrolyte, resulting in loss of capacity and increased swelling; and when the percentage of FEC is higher than 25%, the mechanical strength of the SEX film formed is too large, which relatively increases the charge exchange impedance of the interface, increasing battery impedance and capacity attenuation in the late cycle. Certainly, in addition to the organic solvent, the liquid electrolyte may further include the foregoing lithium salt and additive, which is not repeated herein again.

Further, the organic solvent further includes ethylene carbonate, dimethyl carbonate, and diethyl carbonate, where a volume ratio of ethylene carbonate, dimethyl carbonate, and diethyl carbonate is 1:1:1 (that is, a ratio of volume percentages (vol %) of EC, DMC, and DEC is 1:1:1).

The electrochemical apparatus further includes a positive electrode plate. The positive electrode plate may be a conventional positive electrode plate in the field. For example, the positive electrode plate may include a positive electrode current collector and a positive electrode functional layer applied on a surface of the positive electrode current collector. Raw materials of the positive electrode functional layer include a positive electrode active material, a conductive agent, and a binder, where a mass ratio of the positive electrode active material, the conductive agent, and the binder may be, for example, 96.7:1.7:1.6. The positive electrode active material may be a conventional lithium-containing active material in the field such as lithium cobaltate (LiCoO₂) or other active materials. The conductive agent and the binder may also be conventional materials in the field. For example, the conductive agent may be conductive carbon black or the like, and the binder may be polyvinylidene fluoride (PVDF) or the like. The positive electrode current collector may be a conventional positive electrode current collector in the field such as aluminum foil.

The electrochemical apparatus further includes a separator for separating the positive electrode plate and the negative electrode plate, to be specific, the separator is located between the positive electrode plate and the negative electrode plate for separation. The separator may be a conventional separator in the field such as a polyethylene (PE) porous polymer film, which is not particularly limited in the present invention.

The electrochemical apparatus of the present invention can be made in accordance with the conventional methods in the field. For example, in some embodiments, the electrochemical apparatus is specifically a wound lithium-ion battery, the preparation process of which may be that: the positive electrode plate, the separator; and the positive electrode plate are stacked, the stack is wound to form a bare cell, the bare cell is placed in an outer package, an electrolyte solution is injected, and processes such as packaging, formation, degassing, and trimming are performed to obtain a full cell (that is, battery). The foregoing processes of winding, electrolyte injection, packaging, formation, degassing, and trimming are all conventional operations in the field and will not be repeated herein.

According to still another aspect of the present invention, an electronic apparatus is provided, including the foregoing electrochemical apparatus.

To make the objectives, technical solutions, and advantages of this invention clearer, the following clearly and completely describes the technical solutions in this invention with reference to some embodiments of this invention. Apparently, the described embodiments are some but not all of de embodiments of this invention. All other embodiments obtained by persons of ordinary skill in the art based on some embodiments of the present invention without creative efforts shall fall within the protection scope of the present invention.

Unless otherwise specified, in the following examples and comparative examples, conventional methods in the field are used for the spectral analysis and performance testing of materials, and the relevant testing processes are briefly described as follows.

(1) Scanning Electron Microscopy (SEM) Representation

This test was performed at 10 kV and 10 mA, and test results were recorded by a Philips XL-30 field emission scanning electron microscopy. a/b values (that is, sphericity) of the particles per unit area (range: 100 μm×100 μm) wee counted to obtain an average value of ab to be used as the a/b value of the nucleus formed after powder grading and physical shaping treatments performed for the SiOC material.

(2) Transmission Electron Microscopy (TEM) Representation

This test was performed using a JEOL JEM-2010 transmission electron microscope with an operating voltage of 200 kV

(3) Test for Percentage of Carbon (Carbon Film)

This test was performed using a high-frequency infrared carbon and sulfur analyzer (Shanghai Dekai HCS-140). The sample was heated and burned in a high-frequency furnace under oxygen-enriched conditions, such that carbon and sulfur were oxidized into carbon dioxide and sulfur dioxide, respectively, and the carbon dioxide gas and the sulfur dioxide gas were caused to enter the respective absorption pools after treatment, so as to absorb the respective infrared radiations, which in turn were converted into respective signals by a detector. The signals were sampled by a computer, linearly corrected, and convened into numerical values which were proportional to concentrations of the carbon dioxide and the sulfur dioxide. Then values taken during the entire analysis process were accumulated After the analysis was completed, in the computer, this accumulated value was divided by the weight value, then multiplied by a correction factor, and subtracted by a blank value to obtain percentages of carbon and sulfur in the sample.

(4) Conductivity Test

This test was performed using a resistivity tester (Suzhou Jingge Electronics ST-2255A): 5 g of powder sample was taken and pressed at a constant pressure of 5000 kg±2 kg for 15 s to 25 s with an electronic pressing machine; the sample was then placed between the electrodes of the tester with a sample height of h (cm), a voltage of U, a current of I, and a resistance of R (KΩ). The area S of the powder-pressed sheet was equal to 3.14 cm², and the powder electronic conductivity was calculated according to the formula δ=h/(S×R)/1000, in S/n.

(5) Test for Resistance Value and Resistivity of Negative Electrode Diaphragm (that is, Negative Electrode Plate)

The four-probe method was used to measure the resistance of the negative electrode diaphragm. The four-probe test instrument was a precision direct-current voltage and current source (model SB118). Four copper plates of 1.5 cm×1 cm×2 mm (length×width×thickness) were fixed equidistantly on a hue, the spacing between the middle two copper plates was L (1 cm to 2 cm), and the substrate for fixing the copper plates was an insulating material. In the test, the lower end faces of the four copper plates were pressed on the negative electrode to be tested (under the pressure of 3000 Kg) for 60 s. The copper plates were connected with a direct current I, the voltage V across the middle two copper plates was measured, values of I and V were read three times, and average values Ia and Va of I and V were taken respectively. The value of Va/Ia was the resistance of the diaphragm at the test point, and a ratio of the resistance to the thickness of the negative electrode plate was the resistivity of the diaphragm. Tests were performed at 12 points for each negative electrode plate, and the average value obtained was the final resistivity of the negative electrode plate.

(6) Cycling Performance Test

Under the test temperature of 25° C. the battery was charged to 4.45 V at a constant current of 0.7 C, charged to 0.025 C at a constant voltage, left standing for 5 minutes, and then discharged to 3.0 V at 0.5 C. The capacity obtained from this step was the initial capacity. Then the 0.7 C charge/0.5 C discharge cycle test was conducted. The ratio of the capacity at each step to the initial capacity was the capacity retention rate, and then the capacity attenuation curve (that is, the relationship curve between the capacity retention rate after cycling and the number of cycles) was obtained.

(7) Battery Full-Charge Swelling Rate Test

A thickness do of a half-charged battery was tested with a spiral micrometer. Then, after 400 cycles, the battery was fully charged, a thickness d& of the battery was measured with the spiral micrometer and compared with the thickness do of the initial half-charged battery to obtain a swelling rate of the fully-charged battery (to be specific, swelling rate=d₀/dₓ).

### Example 1

(1) Preparation of SiOC Composite Material

(11) 10 g of glucose was dissolved in 200 mL of xylene solvent, and after complete dissolution, 20 g of polydimethylsiloxane (whose monomer was C₂H₆OSi) was added into the resulting mixture and stirred for 4 h to fully mix glucose with polydimethylsiloxane in xylene solvent, and the resulting mixed system was subsequently stirred and heated at 80° C. to remove the solvent, and then the product was dried in an oven at 80° C. for 24 h to obtain the dried product.

(12) The dried product was put into a tube furnace for pyrolysis in N₂ used as the protective atmosphere, and subjected to the following heating procedure: The product was heated to 500° C. at a heating rate of 1° C./min, held at this temperature for 30 min, then heated to 1100° C. at a heating rate of 3° C./min, and held at this temperature for 3 h. The SiOC material was obtained.

(13) The SiOC material was subjected to demagnetization, powder grading and physical shaping treatments in turn to form a powder product consisting of nuclei with a/b=0.85 (denoted as SiOC-0.85).

(14) The powder product was fed to the CVD vapor phase furnace. Ar was introduced into the furnace to remove the air in the furnace, and after the air in the furnace was exhausted, the furnace was heated to 960° C. at a heating rate of 20° C./min. After 10 min. methane (that is, carbon source gas with a gas flow rate of 300 mL/min) was fed in, the temperature was held at 960° C. for 120 min (that is, CVD duration), and then the carbon source gas was immediately turned off. The furnace was cooled down to room temperature under Ar atmosphere, and then the powder product was removed from the furnace to obtain the SiOC composite material product (a powder product containing the foregoing nuclei and particles coating the surface of the nuclei, the particles were denoted as SiOC-0.85 @C). The thickness of the carbon film was 20 nm±5 nm, the particle size of the nucleus was 5.5 μm, and the mass percentage of carbon film in SiOC-0.85 @C was 2.5±0.5%.

(2) Preparation of Negative Electrode Plate

(21) 400 g of the SiOC composite material product was taken and physically mixed with 2400 g of artificial graphite to obtain a negative electrode active material.

(22) In the MSK-SFM-10 vacuum stirrer, the negative electrode active material (about 2.8 kg) and 35 g of conductive agent wen added and stirred for 40 min, 95 g of binder was added and stirred for 60 min to dispersion, and then deionized water was added and stirred for 120 min to obtain the uniform mixed slurry. The stirrer had a revolution speed of 10 r/min to 30 r/min and a rotation speed of 1000 r/min to 1500 r/min.

(23) The foregoing mixed slurry was filtered using a 170-mesh double-layer sieve to obtain a negative electrode slurry. The negative electrode slurry had a viscosity of 1500 mPas to 4000 mPas and a solid percentage of 40±5%.

The negative electrode slurry was applied on two surfaces of the copper foil current collector (that is, negative electrode current collector) with a coating thickness of 80 μm. After drying and cold pressing, negative electrode functional layers were formed on the surfaces of the negative electrode current collector to obtain a negative electrode plate. The negative electrode functional layer had a compacted density of 1.76 g/cm³.

(3) Preparation of Positive Electrode Plate and Battery

(31) LiCoO₂, conductive carbon black, and PVDF were fully stirred at a weight ratio of 96.7:1.7:1.6 in N-methylpyrrolidone and mixed well, then the resulting mixture was applied on two surfaces of Al foil (that is, positive electrode current collector); then after drying and cold pressing, positive electrode functional layers were formed on the positive electrode current collector to obtain a positive electrode plate.

(32) PE porous polymer film was used as the separator. The foregoing positive electrode plate, separator, and negative electrode plate were stacked in sequence such that the separator was sandwiched between the positive electrode plate and the negative electrode plate for separation, and then the stack was wound to form a bare cell, and the bare cell was placed in an outer package, into which an electrolyte solution was injected, the outer package was sealed, and then after processes such as formation, degassing, and trimming, a lithium-ion battery was obtained. The electrolyte consisted of LiPF₆, an organic solvent, and an additive. The organic solvent consisted of EC, DMC, DEC, and FEC, where a ratio of volume percentages (vol %) of EC, DMC, and DEC in the organic solvent was EC:DMC:DEC=1:1:1, and a mass percentage of FEC in the electrolyte was 10%. A concentration of LiPF₆ in the electrolyte was 1 mol/L. The additive included TFPB, 12-crown-4 ether, and VC, where a concentration of TFPB in the electrolyte was 0.1 mol/L, a concentration of 12-crown-4 ether in the electrolyte was 0.05 mol/L, and a concentration of VC in the electrolyte was 0.1 mol/L.

### Examples 2 to 9

Examples 2, 3 and 4 vary from Example 1 in that the sphericity (that is, a/b value) of the nuclei in step (13), as shown in Table 1. Other preparation conditions were the same as those in Example 1.

Example 5 varies from Example 4 in that: the CVD duration in step (14) was 60 min (that is, the temperature was held at 960° C. for 60 min), and correspondingly, the thickness of the formed carbon film coating SiOC-0.85 was 10±5 nm, and the mass percentage of the carbon film in SiOC-0.85 @C was 2.0±0.5%. Other preparation conditions were the same as those in Example 4.

Example 6 varies from Example 4 in that: the CVD duration in step (14) was 180 min (that is, the temperature was held at 960° C. for 180 min), and correspondingly, the thickness of the formed carbon film coating SiOC-0.85 was 30±5 nm, and the mass percentage of the carbon film in SiOC-0.85 @C was 4.0±0.5%. Other preparation conditions were the same as those in Example 4.

Example 7 varies from Example 4 in that the carbon source gas in step (14) was acetylene. Other preparation conditions were the same as those in Example 4, and the thickness of the carbon film and the mass percentage of the carbon film in the formed particles were basically the same as those in Example 4.

Example 8 varies from Example 4 in that the carbon source gas in step (14) was ethylene. Other preparation conditions were the same as those in Example 4, and the thickness of the carbon film and the mass percentage of the carbon film in the formed particles were basically the same as those in Example 4.

Example 9 varies from Example 4 in that the carbon source gas in step (14) was a mixture of methane and ethylene, where a volume ratio of methane to ethylene was 7:3. Other preparation conditions were the same as those in Example 4, and the thickness of the carbon film and the mass percentage of the carbon film in the formed particles were basically the same as those in Example 4.

### Comparative Example 1

This comparative example varies from Example 4 in that step (14) was not performed, that is, no carbon coating was performed. Other preparation conditions were the same as those in Example 4.

### Comparative Example 2

This comparative example varies from Example 4 in that the sphericity a/b of the nucleus in step (13) was equal to 0.5. Other preparation conditions were the same as those in Example 4.

### Comparative Example 3

This comparative example varies from Example 4 in that the thickness of the carbon film was 5 nm±3 nm and the mass percentage of the carbon film was 1.0±0.5% in the particles formed at the CVD duration of 30 min (that is, the temperature was held at 960′C for 30 min) in step (14). Other preparation conditions were the same as those in Example 4.

### Comparative Example 4

This comparative example varies from Example 4 in that the thickness of the carbon film was 40 nm±5 nm and the mass percentage of the carbon film was 5.0±0.5% in the particles formed at the CVD duration of 240 min (that is, the temperature was held at 960° C. for 240 min) in step (14). Other preparation conditions were the same as those in Example 4.

### Comparative Example 5

This comparative example varies from Example 4 in that a percentage of the FEC in the electrolyte was 0 (that is, no FEC) in step (32). Other preparation conditions were the same as those in Example 4.

### Comparative Example 6

This comparative example varies from Example 4 in that a percentage of the FEC in the electrolyte was 30 wt % in step (32). Other preparation conditions were the same as those in Example 4.

Performance Test and Result Analysis

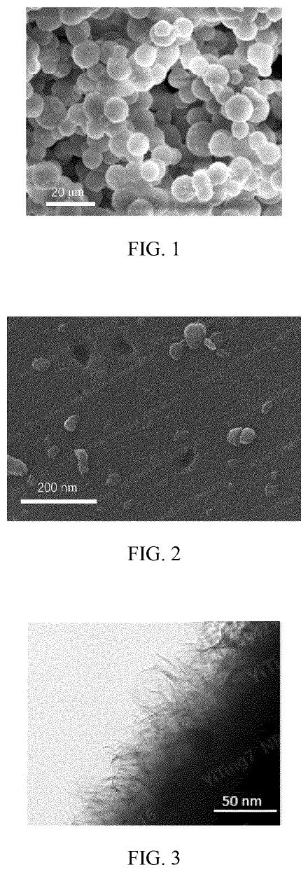

(1) The SiOC composite material product of Example 4 was analyzed using scanning electron microscopy (SEM) and TEM. The SEM images were shown in FIG. 1 and FIG. 2, and the TEM images were shown in FIG. 3. It can be more obviously seen from FIG. 2 and FIG. 3 that the particles of the SiOC composite material product had a surface microscopic morphology in the form of fiber and the fiber length measured ranged from 20 nm to 50 mm.

The SEM and TEM images of Examples 1, 2, 3, 5, 6, 7, 8 and 9 were similar to those of Example 4, in which the particles of the SiOC composite material had a surface microscopic morphology of fibers and the fiber length measured was basically the same as that of Example 4.

(2) In Raman spectroscopy test results of the SiOC composite material product of Example 4, a ratio of peak height I₅₁₀ at 510 cm⁻¹, peak height I₁₃₅₀ at 1350 cm⁻¹, and peak height I₁₅₈₀ at 1580 cm⁻¹ satisfies I₁₃₅₀/I₁₅₈₀=1.8 and I₅₁₀/I₁₃₅₀=0.

In measured Raman spectroscopy results of Examples 1, 2, 3, 5 and 6, I₁₃₅₀/I₁₅₈₀=1.8 and 1510/1350=0.

In measured Raman spectroscopy results of Examples 7, 8, and 9, I₁₃₅₀/I₁₅₈₀=1.2 and I₅₁₀/I₁₃₅₀=0.

(3) Solid-state nuclear magnetic resonance (sNMR) analysis was performed for the SiOC composite material product of Example 4, and positions of element silicon mainly included −5 ppm, −35 ppm, −75 ppm, and −110 ppm, and a half-peak width K at −5 ppm was 20 ppm.

The other measured sNMR results of Examples 1, 2, 3, 5, 6, 7, 8, and 9 were basically the same as those of Example 4.

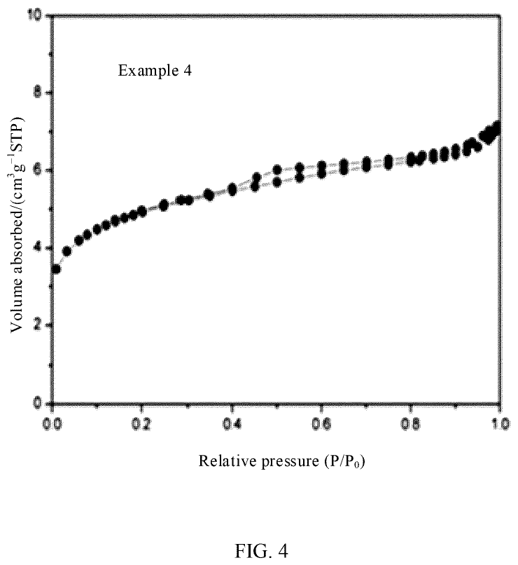

(4) The measured nitrogen adsorption isotherm of the SiOC composite material product of Example 4 was shown in FIG. 4. It can be seen that the nitrogen adsorption isotherm was of type IV, indicating that the particles in the SiOC composite material product had a porous structure, specifically composed of microporous and mesoporous. The nitrogen adsorption test results of Examples 1, 2, 3, 5, 6, 7, 8, and 9 were similar to those of Example 4, and nitrogen adsorption isotherms in Examples 1, 2, 3, 5, 6, 7, 8, and 9 were of type IV.

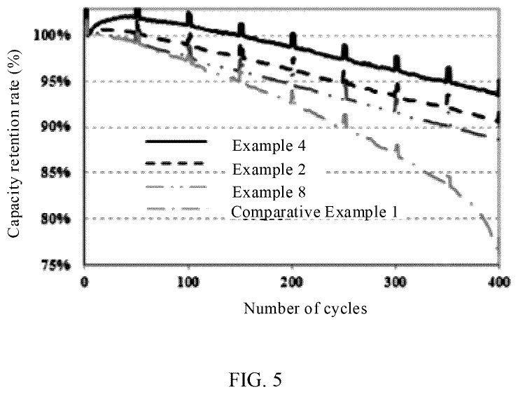

(5) The measured capacity retention rates of the batteries of Examples 1, 2, 3, 4, 5, 6, 7, 8, and 9 and Comparative Examples 1, 2, 3, 4, 5, and 6 after 400 cycles at 25° C. were shown in Table 1. To more clearly illustrate the differences in cycling performance of the batteries between examples and comparative examples, Examples 2, 4, and 8 and Comparative Example 1 were further used as an example to illustrate capacity attenuation curves during cycling of the batteries, as shown in FIG. 5.

The CVD duration, carbon source gas, percentage of FEC in the electrolyte solution, sphericity of the nuclei of the SiOC composite material in the SiOC composite material product (that is, a/b value of fresh powder), conductivity of the SiOC composite material product, sphericity of the nuclei of the SiOC composite material in the negative electrode active material after 400 cycles of the cell (that is, a/b value after 400 cycles), resistivity of the negative electrode plate, resistance of the negative electrode plate after 400 cycles, and swelling rate after 400 cycles were summarized in Table 1.

TABLE 1
Preparation parameters and performance test results for materials of examples and comparative examples

| | | | | | | | | Negative | | |
|---|---|---|---|---|---|---|---|---|---|---|
| | | | | | | Resistivity | | electrode | | |
| | | | | a/b | Conductivity | of | Value | plate | | |
| | | | | value | of SiOC | negative | of a/b | resistance | Battery | |
| | CVD | Carbon | Percentage | of | composite | electrode | after | value Ω | capacity | Battery |
| | time | source | of FEC in | fresh | material | plate | 400 | after 400 | retention | swelling |
| Examples | min | gas | electrolyte | powder | (S/cm) | Ω/cm | cycles | cycles | rate* % | rate % |
| Example 1 | 120 | Methane | 10% | 0.85 | 2.35 | 0.63 | 0.86 | 1.25 | 90.1% | 6.5% |
| Example 2 | 120 | Methane | 10% | 0.90 | 2.34 | 0.63 | 0.90 | 1.20 | 91.3% | 6.0% |
| Example 3 | 120 | Methane | 10% | 0.94 | 2.35 | 0.66 | 0.94 | 1.13 | 92.3% | 5.7% |
| Example 4 | 120 | Methane | 10% | 0.98 | 2.36 | 0.65 | 0.98 | 0.97 | 93.5% | 4.8% |
| Example 5 | 60 | Methane | 10% | 0.98 | 1.90 | 0.70 | 0.98 | 1.25 | 89.3% | 6.9% |
| Example 6 | 180 | Methane | 10% | 0.98 | 3.90 | 0.48 | 0.98 | 1.16 | 89% | 7.1% |
| Example 7 | 120 | Acetylene | 10% | 0.98 | 2.73 | 0.56 | 0.98 | 1.51 | 87.3% | 7.3% |
| Example 8 | 120 | Ethylene | 10% | 0.98 | 2.85 | 0.52 | 0.98 | 1.40 | 88.2% | 7.3% |
| Example 9 | 120 | Methane | 10% | 0.98 | 2.51 | 0.59 | 0.98 | 1.31 | 89.5% | 6.6% |
| | | Ethylene | | | | | | | | |
| Comparative | 0 | / | 10% | 0.98 | 0 | 1.05 | 0.98 | 1.70 | 77.1% | 6.0% |
| Example 1 | | | | | | | | | | |
| Comparative | 120 | Methane | 10% | 0.5 | 2.33 | 0.64 | 0.5 | 1.75 | 81.2% | 9.0% |
| Example 2 | | | | | | | | | | |
| Comparative | 30 | Methane | 10% | 0.98 | 1.04 | 0.88 | 0.98 | 1.38 | 82.3% | 8.1% |
| Example 3 | | | | | | | | | | |
| Comparative | 240 | Methane | 10% | 0.98 | 4.50 | 0.41 | 0.98 | 1.30 | 85.3% | 7.8% |
| Example 4 | | | | | | | | | | |
| Comparative | 120 | Methane | 0 | 0.98 | 2.36 | 0.65 | 0.75 | 2.03 | 65.2% | 10.6% |
| Example 5 | | | | | | | | | | |
| Comparative | 120 | Methane | 30% | 0.98 | 2.36 | 0.65 | 0.98 | 1.54 | 78.5% | 9.5% |
| Example 6 | | | | | | | | | | |

*indicates the capacity retention rate of the battery after 400 cycles.

It can be seen from Examples 1, 2, 3, and 4 and Comparative Example 2 that the a/b value (that is, sphericity) of the SiOC nucleus closer to 1 leads to a higher capacity retention rate of the battery after the cycling and a smaller cyclic swelling, which means that when the a/b value is closer to 1, the particles of the SiOC composite material are closer to spherical, performances such as material isotropy and swelling stress are distributed more uniformly, and thus better capacity retention and swelling suppression effects are achieved for the battery.

It can be seen from Examples 4, 5 and 6 and Comparative Examples 3 and 4 that the CVD duration has a greater impact on the material performance, and compared with Comparative Examples 3 and 4, Examples 4, 5, and 6 have significant improvement effects in terms of cycling and swelling of SiOC composite material, and especially Example 4 has the most significant improvement effect.

In addition, compared with Comparative Example 1, the SiOC composite materials of Examples 1, 2, 3, 4, 5, 6, 7, 8, and 9 have significant effects in terms of conductivity, capacity retention rate, and swelling rate, especially when the carbon source gas contains methane, it is more conducive to improving the capacity retention rate of the battery and reducing the swelling rate of the battery. Specifically. SiOC has poor conductivity and low cyclic capacity. Coating a carbon film on the surface of SiOC particle through a CVD vapor deposition method can significantly improve the conductivity. In addition, the surface layer of the particles has a fibrous structure which can implement long-range conductivity. This can further improve the performance such as conductivity of the SiOC composite material during the cycling, such that the battery exhibits higher capacity retention rate, lower swelling rate, and the like.

It can be seen from Example 4 and Comparative Examples 5 and 6 that the electrolyte has a greater impact on the capacity retention rate and swelling rate of the battery, and the battery of Example 4 has significantly better capacity retention rate and swelling rate than the batteries of Comparative Examples 5 and 6.

To sum up, through physical shaping, the SiOC material tends to be a more regular spherical structure, which can homogenize the swelling stress during the cycling and alleviate the cyclic swelling of the battery cell. The fibrous carbon coating on the surface can significantly improve the conductivity of SiOC materials during the battery cycling and improve cycling performance. Therefore, silicon negative electrode materials (that is, SiOC composite material) with good performance such as long cycling and low swelling can be obtained by controlling conditions such as 0.8<a/b≤1.

Some embodiments of the present invention have been described above. However, the present invention is not limited to the foregoing embodiments. Any modification, equivalent replacement, or improvement made without departing from the spirit and principle of this invention shall fall within the protection scope of the present invention.

What is claimed is:

1. A SiOC composite material, wherein the SiOC composite material is in the form of particles, wherein each particle comprises a nucleus formed from a SiOC material, and the nucleus has a carbon film present on the surface; and a short axis of a largest cross section of the nucleus of the particles is a, a long axis is b, 0.8≤a/b≤1, and the particles have a porous structure.

2. The SiOC composite material according to claim 1, wherein the carbon film has a thickness of 15 nm to 50 nm, and/or the nucleus has an average particle size of 5 μm to 15 μm;
the particles have a surface microscopic morphology of fibers, and the fiber has a fiber length of 15 nm to 50 nm; and
the carbon film in the particle has a mass percentage of 2% to 4%.

3. The SiOC composite material according to claim 2, wherein the carbon film has a thickness of 15 nm to 30 nm, and/or the nucleus has an average particle size of 5 μm to 10 μm.

4. The SiOC composite material according to claim 2, wherein the fiber has a fiber length of 20 nm to 50 nm.

5. The SiOC composite material according to claim 1, wherein in Raman spectroscopy test results of the SiOC composite material, a ratio of peak height I₅₁₀ at 510 cm⁻¹, peak height I₁₃₅₀ at 1350 cm⁻¹, and peak height I₁₅₈₀ at 1580 cm⁻¹ satisfies 1.0<I₁₃₅₀/I₁₅₈₀<3 and I₅₁₀/I₁₃₅₀=0; and
positions of element silicon in sNMR detection results of the SiOC composite material comprise −5 ppm, −35 ppm, −75 ppm, and −110 ppm, and a half-peak width K at −5 ppm satisfies 7 ppm<K<28 ppm.

6. The SiOC composite material according to claim 1, wherein the particles have microporous and mesoporous structures.

7. A preparation method of the SiOC composite material according to claim 1, the method comprising:
performing pyrolysis treatment for a raw material system containing an organic silicon source to obtain the SiOC material;
performing powder grading and physical shaping treatments for the SiOC material to form a product containing the nuclei; and
forming a carbon film on the surface of the nucleus in the product through chemical vapor deposition to obtain the SiOC composite material in the form of the particles.

8. A negative electrode active material, comprising the SiOC composite material according to claim 1, wherein the SiOC composite material has a mass percentage of not lower than 5% in the negative electrode active material.

9. A negative electrode plate, comprising a negative electrode current collector and a functional layer applied on at least one surface of the negative electrode current collector, wherein a negative electrode active material of the functional layer comprises the SiOC composite material according to claim 1 and the functional layer has a thickness of 70 μm to 90 μm and/or a compacted density of 1.5 g/cm³ to 2.0 g/cm³.

10. A preparation method of the negative electrode plate according to claim 9, the method comprising: applying a shiny containing a raw material of the functional layer to at least one surface of the negative electrode current collector and forming the functional layer to obtain the negative electrode plate, wherein the slurry has a solid percentage of 35% to 50%; and/or the slurry has a viscosity of 1500 mPas to 4000 mPas.

11. An electrochemical apparatus, comprising the negative electrode plate according to claim 9; wherein
the electrochemical apparatus comprises a liquid electrolyte containing an organic solvent, wherein the organic solvent comprises vinyl fluorocarbonate, and the vinyl fluorocarbonate has a mass percentage of 3% to 25% based on a total mass of the liquid electrolyte.
